(19) United States
(12) Patent Application Publication
(10) Pub. No.: US 2005/0281212 A1
(43) Pub. Date: Dec. 22, 2005

(54) Wireless access communication system for data retransmission, data retransmission apparatus and method

(75) Inventors: Hye-Yeon Jeong, Suwon-si (KR); Sung-Wook Park, Yongin-si (KR); Jong-Hyun Won, Seoul (KR); Tae-In Hyon, Hwaseong-si (KR); Sun-Ny Chang, Suwon-si (KR); Jin-A Kim, Seoul (KR); Kang-Gyu Lee, Yongin-si (KR); Yun-Sung Kim, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/027,097

(22) Filed: Dec. 30, 2004

(30) Foreign Application Priority Data
Jun. 18, 2004 (KR) 45608/2004

(51) Int. Cl. H04B 7/00

(52) U.S. Cl. 370/310

(57) ABSTRACT

An apparatus and method for re-transmitting data in a wireless access communication system are disclosed. The data retransmission method in a wireless access communication system performing a data transmission/reception operation between a terminal and a base station using ARQ (Automatic Repeat Request) includes the step of transmitting allocation information for bandwidth for data retransmission with respect to data received by the base station and ARQ feedback information according to an error which is included in the received data from the base station to the terminal, and re-transmitting the data in which the error had occurred through the allocated bandwidth based on the allocation information of the bandwidth for the data retransmission from the terminal to the base station.

### PRIORITY

This application claims priority to an application entitled “WIRELESS ACCESS COMMUNICATION SYSTEM FOR DATA RETRANSMISSION, DATA RETRANSMISSION APPARATUS AND METHOD”, filed in the Korean Intellectual Property Office on Jun. 18, 2004 and assigned Serial No. 2004-45608, the contents of which are hereby incorporated by reference.

### BACKGROUND OF THE INVENTION

1. Field of the Invention

The present invention relates to an apparatus and method for re-transmitting data in a wireless access communication system, and more particularly to a bandwidth allocation apparatus and method for rapidly re-transmitting data using an ARQ (Automatic Repeat reQuest).

2. Description of the Related Art

Recently, the wireless access communication system (referred to as 4th generation communication system or IEEE 802.16 communication system) has undergone extensive researched and has been developed to support high speed and high quality services. An ARQ (Automatic Repeat reQuest) may be used to reliably perform data transmission in the wireless access communication system. As shown in FIG. 1, a terminal 100 and a base station 102, which employ the ARQ, transmit an ACKnowledgement (hereinafter referred to as ACK) and a NACKnowledgeent (hereinafter referred to as NACK), to each other to indicate whether or not received data contains an error.

FIG. 1 is a block diagram illustrating a base station and a terminal in a general wireless access communication system. The terminal 100 performs a registration process when initially entering a network connected to the base station 102. Also, the terminal 100 determines if an ARQ is used when the connection is initially attempted in a dynamic service flow between the terminal 100 and the base station 102. The terminal 100 and the base station 102, which are using an ARQ, transmit to each other information for ACK and NACK with respect to received data blocks. Such information for ACK and NACK is transmitted between the terminal and base station in a format of “ARQ_FEEDBACK_Information_Element.” Hereinafter ARQ feedback information will be used to refer to the ACK and NACK information.

When ARQ feedback information received in a receiver side is a NACK, the receiver side retransmits the corresponding data within a predetermined time. If the terminal 100 receives NACK ARQ feedback information from the base station 102, the terminal 100 should re-transmit the corresponding data to the base station 102.

A detailed description for general data retransmission between the base station 102 and terminal 100 will be described with reference to FIG. 2. Namely, FIG. 2 is a diagram illustrating a procedure for data retransmission between a base station and a terminal in a general wireless access communication system.

When a data frame is transmitted from the terminal 100 to the base station 102 in step 200, the base station 102 determines if an error is included in the data in the data frame in step 202. The base station 102 performs received data processes such as data retrieval and dechannelization, and then a CRC operation to determine if there are any errors in the received data. The base station 102 then determines if the received data contains an error based on a result of the CRC operation.

If it is determined that the received data doesn't contain an error based on the result of the CRC operation in step 202, the base station 102 transmits an ACK information to the terminal 100 in step 204. However, if it is determined that the received data contains an error in step 202, the base station 102 transmits an NACK information to the terminal 100 in step 206. The terminal 100 determines if the NACK information is received in step 208. If the terminal 100 receives the NACK information, it requests an allocation of bandwidth for the data retransmission in step 210. If the base station 102 receives the request from the terminal 100, then it allocates the bandwidth for the data retransmission to the terminal 100 in step 212. Then the terminal 100 retransmits the corresponding data to the base station 102 through the allocated bandwidth for data retransmission in step 214.

Data frames including the data used when data is retransmitted from the terminal to the base station will be described in detail with reference to FIG. 3. FIG. 3 is a diagram illustrating frames of transmission/reception data in a terminal when performing data re-transmission according to the procedure of FIG. 2.

In the following example it is presumed that ARQ feedback information is received and the bandwidth for the data retransmission is requested through a subsequent frame. Also, if the base station 102 receives a request for bandwidth for the data retransmission from the terminal 100, the base station 102 allocates the bandwidth after skipping one frame. Further, if the terminal 100 receives the allocated bandwidth from the base station 102, the terminal 100 then transmits the corresponding data to the base station through a subsequent frame.

If the terminal 100 receives a frame 300 including the ARQ feedback information, ARQ_FEEDBACK_IE, from the base station 102, the terminal 100 then requests the allocation for bandwidth for the data retransmission of the base station 102 through a subsequent frame 302.

If the base station 102 receives the request of allocation for bandwidth for data transmission from the terminal 100 through the frame 302, the base station 102 then informs the terminal 100 through a frame 306 after skipping a frame 304, subsequent to the frame 302, that the bandwidth for data retransmission for corresponding data is allocated to a frame 308. Then the terminal 100 retransmits the corresponding data to the base station 102 through the frame 308 having an allocated bandwidth allocated by the base station 102.

If the terminal 100 receives an NACK information from the base station 102, the terminal 100 requests allocation for bandwidth for data retransmission of the base station 102 to retransmit the corresponding data thereto. Then the base station 102 allocates the bandwidth for the data retransmission and informs the terminal 100 of allocation information such that the terminal 100 can retransmit the corresponding data thereto. Here, the terminal 100 should use a part of the allocated bandwidth for a piggyback method, in which the part of allocated bandwidth is similar to an amount of bandwidth for the retransmission of data corresponding to the NACK information.

### SUMMARY OF THE INVENTION

The prior art data retransmission method has disadvantages in that, when a terminal needs to retransmit data to a base station, the terminal must perform complicated processes for the data retransmission. Namely, the terminal should request allocation for bandwidth for the data retransmission of the base station, and then the base station allocates the bandwidth to the terminal and transmits the allocation information to the terminal. After that the terminal can retransmit corresponding data thereto. Also, the prior art data transmission method has a drawback in that part of the bandwidth allocated to retransmit corresponding data is needed by the piggyback method.

Therefore, the present invention has been made in view of at least the above problems, and it is an object of the present invention to provide an apparatus and method for rapidly performing a data retransmission operation with respect to data to be retransmitted in a wireless access communication system.

It is another object of the present invention to provide an apparatus and method for rapidly performing a data retransmission operation with respect to data to be retransmitted according to an ARQ (Automatic Repeat reQuest) feedback information and allocation information of bandwidth for data retransmission transmitted from a base station to a terminal.

In accordance with an aspect of the present invention, the above and other objects can be accomplished by the provision of a wireless access communication system for performing a data retransmission operation using an ARQ (Automatic Repeat Request), including a terminal, and a base station for receiving data from the terminal, and transmitting to the terminal allocation information of bandwidth for data retransmission with respect to the received data and ARQ feedback information, according to an error which is included in the received data, wherein the terminal retransmits the data in which the error has occurred to the base station through allocated bandwidth based on the bandwidth allocation information, if the terminal receives the ARQ feedback information and the allocation information of bandwidth for data retransmission.

In accordance with another aspect of the present invention, there is provided a data retransmission method in a wireless access communication system performing a data transmission/reception operation between a terminal and a base station using an ARQ (Automatic Repeat Request), including the step of transmitting from the base station to the terminal allocation information of bandwidth for data retransmission with respect to data received by the base station and ARQ feedback information, according to an error which is included in the received data, and re-transmitting from the terminal to the base station the data in which the error has occurred through allocated bandwidth based on the bandwidth allocation information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a base station and a terminal in a general wireless access communication system;

FIG. 2 is a diagram illustrating a procedure for data retransmission between a base station and a terminal in a general wireless access communication system;

FIG. 3 is a diagram illustrating frames of transmission/reception data in a terminal when performing data re-transmission according to the procedure of FIG. 2;

FIG. 4 is a flow chart illustrating data retransmission between a base station and terminal according to an embodiment of the present invention;

FIG. 5 is a diagram illustrating frames of transmission/reception data in a terminal when performing data retransmission according to an embodiment of the present invention in FIG. 4; and

FIG. 6 is a flow chart illustrating data retransmission between a base station and terminal according to an embodiment of the present invention.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may obscure the subject matter of the present invention. Also, the terms used in the following description are terms defined taking into consideration the functions obtained in accordance with the present invention.

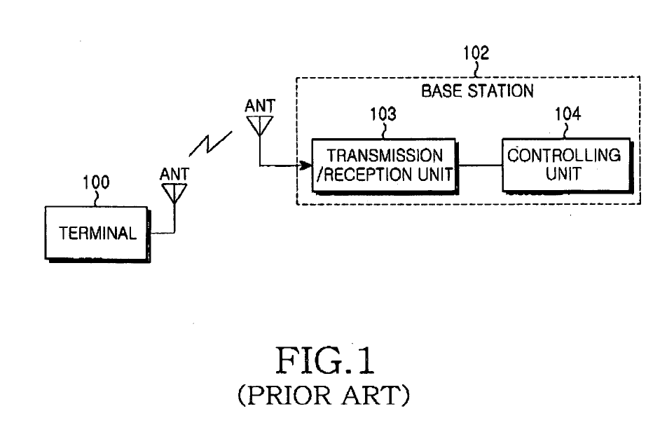

With reference to FIG. 1, the construction and operation of a wireless access communication system according to the present invention will be described in detail below.

A base station 102 is shown to include a controlling unit 104 and a transmission/reception unit 103.

The controlling unit 104 of the base station 102 determines if data from the terminal 100 is successfully received in the base station 102 based on a result of whether an error is included in the data. If the received data contains an error, the controlling unit 104 determines if the bandwidth for the data retransmission can be allocated. The controlling unit 104 determines if the bandwidth for data retransmission can be sufficiently allocated based on the resources of the base station 102. If the bandwidth can be allocated, the controlling unit 104 allocates the bandwidth for the data retransmission corresponding to the quantity of data to be retransmitted. After that, the controlling unit 104 transmits a NACK information and allocation information of the bandwidth for the data retransmission through the transmission/reception unit to the terminal 100.

When the terminal 100 receives the NACK for the data retransmission, the base station 102 transmits an ARQ feedback information and allocation information of the bandwidth for the data retransmission to the terminal 100 such that the terminal 100 can retransmit the data thereto regardless of a request for the bandwidth for data retransmission. The terminal 100 confirms the ARQ feedback information and then rapidly retransmits the corresponding data through the allocated bandwidth to the base station 102.

However, if the base station 102 does not have the resources, it transmits only a NACK information to the terminal 100. After that, general operations for data retransmission are performed.

If the ARQ feedback information to be transmitted to the terminal 100 is NACK information, the base station 102 allocates bandwidth corresponding to the quantity of the data to be retransmitted and then determines if a request for the allocation of the bandwidth for the data transmission has already been made. If a request has already been made, and if the bandwidth for the data retransmission and requested bandwidth can be allocated using the resources of the base station 102, the base station 100 adds the bandwidth for data retransmission to the requested bandwidth and then allocates the added bandwidth. After that, the base station 102 transmits a NACK information and allocated bandwidth information to the terminal 100.

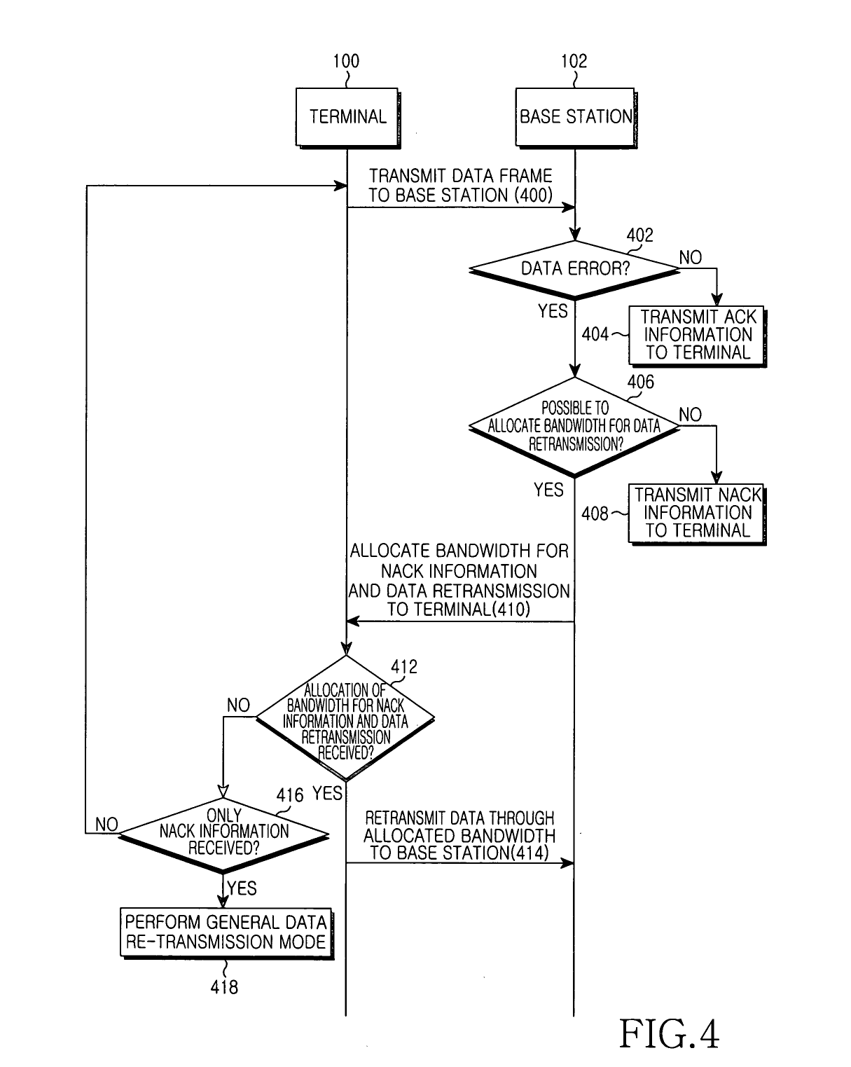

Now, with reference to FIG. 4, data retransmission operations between a base station and terminal will be described in detail below. FIG. 4 is a flow chart for data retransmission between a base station and terminal according to an embodiment of the present invention.

When a data frame is transmitted from the terminal 100 to the base station 102 in step 400, the base station 102 determine if an error is included in the data frame in step 402. The base station 102 performs received data processes such as data retrieval and dechannelization, and then performs a CRC operation to determine if there are any errors in the received data. The base station 102 determines if the receive data contains an error based on a result of the CRC operation. The base station 102 forms the ARQ feedback information (ARQ_FEEDBACK_IE) and at the same time calculates a quantity of data blocks corresponding to the NACK information while the base station 102 determines the validity of received data frames.

If an error is not included in the data frame in step 402, the ACK information is transmitted to the terminal 100. However, if an error is included in the data frame in step 402, the base station 102 determines if there are sufficient resources available to allocate bandwidth such that the data blocks, which contain errors calculated and accumulated in UL-MAP (Up Link-MAP) in step 406, can be retransmitted. If there are sufficient resources to allocate the bandwidth required for the data retransmission based on a result of the determination in step 406, the base station 102 proceeds to step 410 and transmits the NACK information and allocation information of the bandwidth for the data retransmission to the terminal 100 in step 410. If there are not sufficient resources, the base station 102 transmits only the NACK information to the terminal 100.

If the terminal 100 receives the NACK information and allocation information of the bandwidth for the data retransmission in step 412, the base station 101 retransmits the corresponding data to the base station 102 through the allocated bandwidth in step 414.

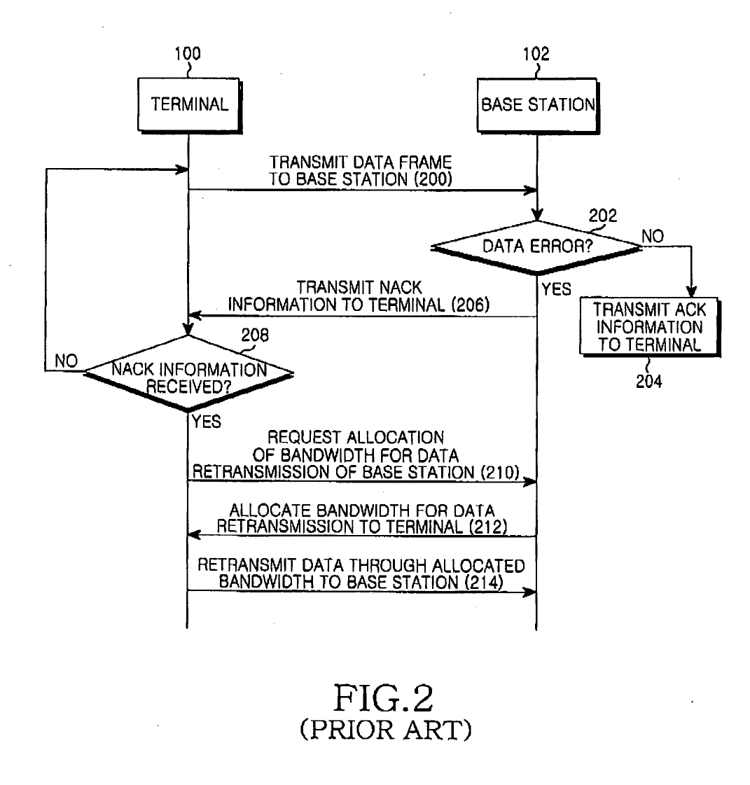

If the terminal 100 does not receive the NACK information and allocation information of the bandwidth for the data retransmission in step 412, the terminal 100 determines if the terminal 100 receives only the NACK information in step 416. If the terminal 100 receives only NACK information in step 416, the terminal 100 proceeds to step 418 and performs a general data retransmission mode. Here, the general data retransmission mode is described as shown in steps 210 to 214 in FIG. 2.

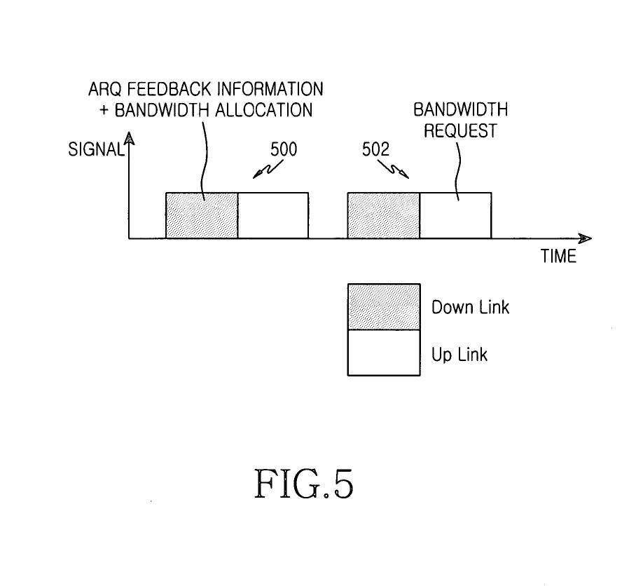

When the data retransmission is performed according to the method as shown in FIG. 4, data frames for data retransmission will be described in detail with reference to FIG. 5. FIG. 5 is a diagram illustrating the frames of the transmission/reception data in a terminal when performing the data retransmission according to an embodiment of the present invention.

The terminal 100 receives a data frame 500 including the ARQ feedback information ARQ_FEEDBACK_IE and the bandwidth allocation information through a downlink from the base station 102. The base station 102 allocates the bandwidth based on a basic CID (channel identification) to UL-MAP (Up Link-MAP) for the terminal 100, and transmits the ARQ feedback information to the terminal 100 through the same downlink frame 500. Then the terminal 100 has the bandwidth allocated according to the basic CID in the UL-MAP, and then receives the ARQ feedback information from the base station. The terminal 100 retransmits data frame 502 including the corresponding data through the bandwidth allocated by the uplink to the base station 102.

For such a data retransmission, the embodiment of the present invention is implemented with at least two data frames.

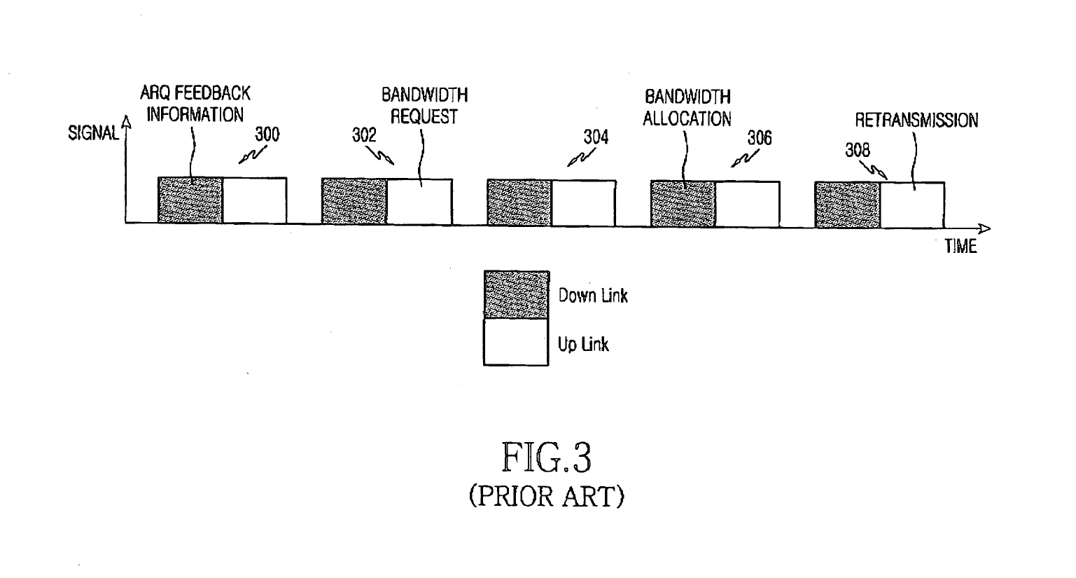

When the prior art data retransmission is performed such that data is transmitted from the terminal to the base station, at least five data frames are needed as shown in FIG. 3. Since the data retransmission method of the present invention needs only at least two data frames, the present invention can rapidly performs the data retransmission operations as compared with the prior art data retransmission method.

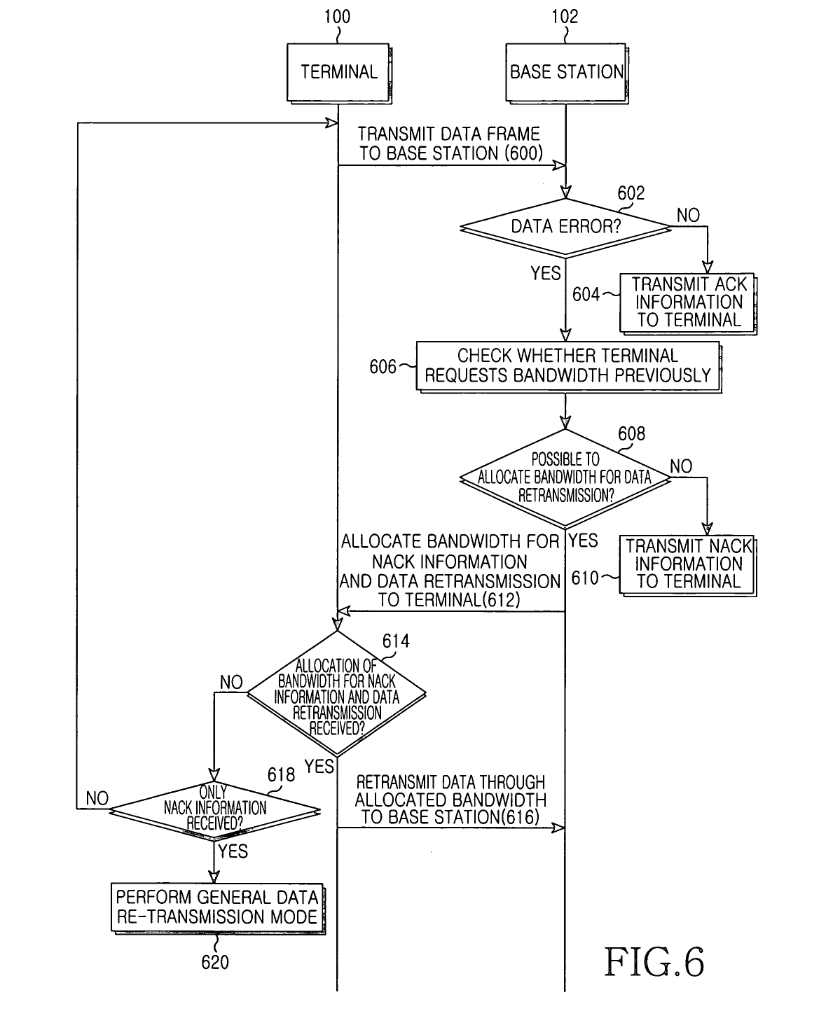

While the base station 102 responds to the ARQ information from the terminal 100 and allocates the bandwidth for the data retransmission as shown in FIG. 4, a case where the terminal 100 requests bandwidth for data transmission will be described with reference to FIG. 6. FIG. 6 is a flow chart illustrating the data retransmission between a base station and terminal according to another embodiment of the present invention.

When a data frame is transmitted from the terminal 100 to the base station 102 in step 600, the base station 200 determines if there are any errors included in the data frame in step 602. If it is determined that an error is not included in the data frame in step 602, the base station 100 transmits the ACK information to the terminal 100 in step 604. If it is determined that an error is included in the data frame, the base station 102 determines if the terminal 100 has previously requested bandwidth for data transmission. Namely, the base station 100 determines if the terminal 100 has previously requested the bandwidth for data transmission according to the quantity of data to be transmitted.

If the terminal 100 has previously requested the bandwidth for the data transmission in step 606, the base station 102 determines if both the bandwidth for the data transmission, which is previously requested, and the bandwidth for the data retransmission can be allocated in step 608. If both the bandwidth for the data transmission, which is previously requested, and the bandwidth for the data retransmission cannot be allocated in step 608, the base station 102 transmits the NACK information to the terminal 100 in step 610.

If both the bandwidth for the data transmission, which is previously requested, and the bandwidth for the data retransmission can be allocated in step 608, the base station 102 allocates both the bandwidth for the data transmission, which is previously requested, and the bandwidth for the data retransmission and transmits the NACK information and allocation information for the bandwidth for the data transmission to the terminal 100 in step 612.

When the terminal 100 receives the NACK information and allocation information for the bandwidth for the data transmission in step 614, the terminal 100 retransmits the corresponding data to the base station 102 through the allocated bandwidth in step 616.

When the terminal 100, however, does not receive the NACK information and allocation information for the bandwidth for the data transmission in step 614, the terminal 100 determines if only the NACK information is received in step 618. If only the NACK information is received in step 618, the terminal 100 performs a general data retransmission mode in step 620. The general data retransmission mode is described as shown in steps 210 to 214 in FIG. 2.

As apparent from the above description, the present invention performs a data retransmission operation in a wireless access communication system such that a base station 102 allocates the bandwidth for re-transmitting data and the ARQ feedback information to a terminal 100 and then the terminal 100 retransmits data through the allocated bandwidth to the base station 102.

As apparent from the above description, the present invention performs a data retransmission operation such that a base station allocates the bandwidth for re-transmitting data and information for data retransmission to a terminal and then the terminal rapidly retransmits data through the allocated bandwidth to the base station. Namely, the present invention has advantages in that the data retransmission can be rapidly performed since the steps of requesting the bandwidth for the data retransmission by a terminal and of receiving the request and allocating the bandwidth therefor by the base station are not performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wireless access communication system for performing a data retransmission operation using an ARQ (Automatic Repeat Request), comprising:
a terminal; and
a base station for receiving data from the terminal, and transmitting to the terminal allocation information related to bandwidth required for data retransmission with respect to the received data and ARQ feedback information according to an error which is included in the received data,
wherein the terminal retransmits to the base station the data in which the error has occurred through the allocated bandwidth based on the allocation information of the bandwidth for the data retransmission.

2. An apparatus for allocating bandwidth for data retransmission in a wireless access communication system, comprising:
a transmission/reception unit for performing a data transmission/reception operation; and
a controlling unit for transmitting allocation information related to bandwidth required for data retransmission with respect to received data and ARQ (Automatic Repeat Request) feedback information according to an error which is included in the received data through the transmission/reception unit.

3. The apparatus as set forth in claim 2, wherein the controlling unit calculates the bandwidth for the data retransmission for the received data if the error is included in the received data, allocates the bandwidth for the data retransmission if the calculated bandwidth is available, and transmits the ARQ feedback information and information for the allocated bandwidth through the transmission/reception unit.

4. The apparatus as set forth in claim 2, wherein the controlling unit calculates the bandwidth for the data retransmission, if a bandwidth allocation request is received before receiving the data, and the bandwidth based on the bandwidth allocation request, and allocates the bandwidth for the data retransmission and the bandwidth based on the bandwidth allocation request if the calculated bandwidths are available.

5. The apparatus as set forth in claim 3, wherein the controlling unit transmits the ARQ feedback information through the transmission/reception unit if the calculated bandwidth is not available.

6. The apparatus as set forth in claim 4, wherein the controlling unit transmits the ARQ feedback information through the transmission/reception unit if the calculated bandwidth is not available.

7. A data retransmission method in a wireless access communication system performing a data transmission/reception operation between a terminal and a base station using an ARQ (Automatic Repeat Request), comprising the step of:
transmitting allocation information for bandwidth for data retransmission with respect to data received by the base station and ARQ feedback information according to an error which is included in the received data from the base station to the terminal; and
re-transmitting the data in which the error had occurred using the allocated bandwidth based on the allocation information of the bandwidth for the data retransmission from the terminal to the base station.

8. A bandwidth allocation method for data retransmission in a base station of a wireless access communication system performing a data transmission/reception operation between a terminal and the base station using an ARQ (Automatic Repeat Request), comprising the steps of:
receiving data from the terminal; and
transmitting allocation information for bandwidth for data retransmission with respect to the received data and ARQ feedback information according to an error which is included in the received data from the base station to the terminal.

9. A bandwidth allocation method for data retransmission in a base station of a wireless access communication system performing a data transmission/reception operation between a terminal and the base station using an ARQ (Automatic Repeat Request), comprising the steps of:
if data received from the terminal contains an error, calculating bandwidth required for data retransmission for the received data;
determining if the calculated bandwidth can be allocated; and
if the calculated bandwidth can be allocated, allocating the bandwidth for the data retransmission, and transmitting the ARQ feedback information and information for the allocated bandwidth to the terminal.

10. The method as set forth in claim 9, further comprising the step of:
if the calculated bandwidth can not be allocated, transmitting the ARQ feedback information to the terminal.

11. A bandwidth allocation method for data retransmission in a base station of a wireless access communication system performing a data transmission/reception operation between a terminal and the base station using an ARQ (Automatic Repeat Request), comprising the step of:
if data received from the terminal contains an error, determining if a bandwidth allocation request is requested from the terminal before receiving the data from the terminal;
if the bandwidth allocation request is requested, calculating bandwidth required for data retransmission of the data and bandwidth corresponding to the bandwidth allocation request;
determining if the calculated bandwidth can be allocated; and
if the calculated bandwidth can be allocated, allocating the bandwidth for the data retransmission and the bandwidth corresponding to the bandwidth allocation request, and transmitting the ARQ feedback information according to an error which is included in the received data and information for the allocated bandwidth from the base station to the terminal.

12. The method as set forth in claim 11, further comprising the step of:
if the calculated bandwidth can not be allocated, transmitting the ARQ feedback information according to an error which is included in the received data from the base station to the terminal.
